(19) United States
(12) Patent Application Publication
(10) Pub. No.: US 2005/0268023 A1
(43) Pub. Date: Dec. 1, 2005

(54) Multi-port random access memory

(76) Inventors: Randall Don Briggs, Boise, ID (US); Greg Lee Allen, Boise, ID (US)

Correspondence Address: AGILENT TECHNOLOGIES, INC.;Intellectual Property Administration, Legal Department, DL 429, P.O. Box 7599, Loveland, CO, 80537-0599, US

(21) Appl. No.: 10/858,748

(22) Filed: Jun. 1, 2004

(51) Int. Cl. G06F 12/00

(52) U.S. Cl. 711/5; 711/105

(57) ABSTRACT

A memory system is presented. The memory system includes a plurality of memory banks, a plurality of busses and a selection mechanism. The selection mechanism is connected to every memory bank in the plurality of memory banks and to every bus in the plurality of busses. The selection mechanism is able to select any memory bank from the plurality of memory bank to connect to any bus from the plurality of busses.

### BACKGROUND

In a traditional dynamic random access memory (DRAM) circuit, memory is apportioned into DRAM banks. Circuit blocks, for example, within an application specific integrated circuit (ASIC), accessing the DRAM memory typically utilize a DRAM controller external to the DRAM circuit. Circuit blocks can include, for example, one or more of the following: a central processing unit (CPU), an input/output (I/O) bus interface, a printer controller interface, a compressor, a multiplier, and/or other devices that use direct memory access (DMA). The circuit blocks communicate with the DRAM controller through a central bus.

Through a single random access memory (RAM) interface, the DRAM controller is able to access one of the DRAM banks of the DRAM circuit. Within the DRAM circuit, the DRAM banks are arranged so that only one DRAM bank can be accessed at a time.

There are several bottlenecks that can occur in this traditional system. For example, all access to DRAM circuit utilizes the central bus. The circuit blocks connected to the central bus have to share the bus. When the central bus allows peer-to-peer data traffic flowing between the circuit blocks this can further limit bandwidth and can increase latency for data transfers involving the DRAM circuit. When the DRAM circuit is accessed using a single data port, this can further limit performance.

### SUMMARY OF THE INVENTION

In accordance with embodiments of the present invention, a memory system is presented. The memory system includes a plurality of memory banks, a plurality of busses and a selection mechanism. The selection mechanism is connected to every memory bank in the plurality of memory banks and to every bus in the plurality of busses. The selection mechanism is able to select any memory bank from the plurality of memory bank to connect to any bus from the plurality of busses.

### BRIEF DESCRIPTION OF THE DRAWINGS

FIG. 1 is a simplified block diagram of a multiport, multibus memory system in accordance with an embodiment of the present invention.

FIG. 2 is a simplified block diagram of a multiplex block used in the multiport, multibus memory system shown if FIG. 1 in accordance with an embodiment of the present invention.

FIG. 3 is a simplified block diagram of a multiport, multibus memory system in accordance with another embodiment of the present invention.

### DESCRIPTION OF THE EMBODIMENT

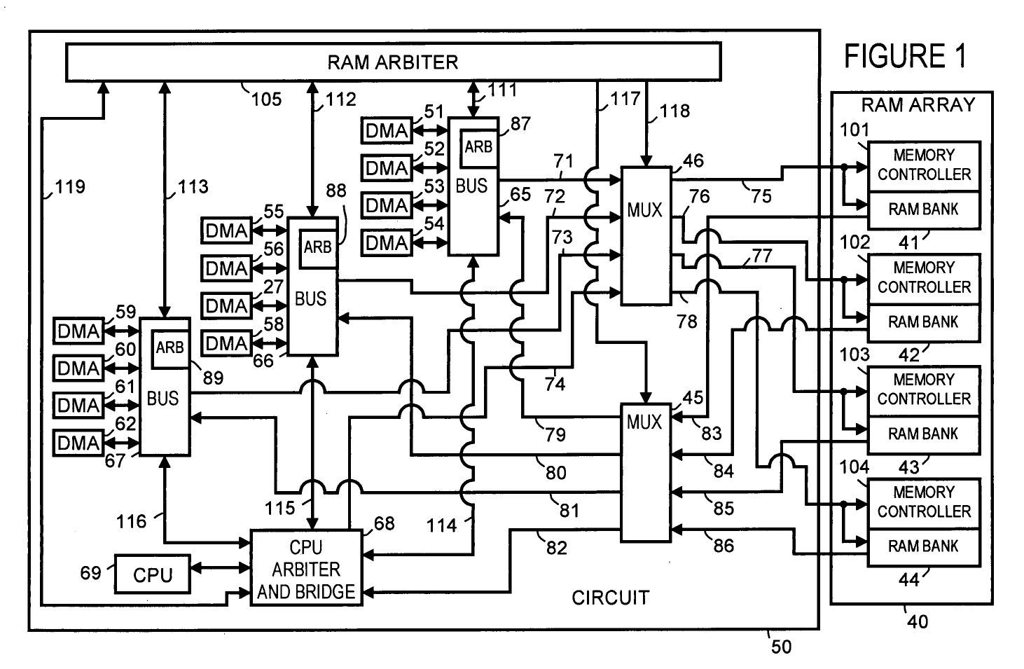

FIG. 1 is a simplified block diagram of a multiport, multibus memory system. A RAM array 40 includes a RAM bank 41, a RAM bank 42, a RAM bank 43 and a RAM bank 44. For example, RAM bank 41, RAM bank 42, RAM bank 43 and RAM 44 are all implemented using DRAM memory. Alternatively, other types of RAM such as static RAM (SRAM) or ferroelectric random access memory (FERAM) can be used to implement RAM bank 41, RAM bank 42, RAM bank 43 and RAM 44. A memory controller 101 controls memory access to RAM bank 41. A memory controller 102 controls memory access to RAM bank 42. A memory controller 103 controls memory access to RAM bank 43. A memory controller 104 controls memory access to RAM bank 44.

A circuit 50 accesses data stored in RAM array 40. Circuit 50 is, for example, an application specific integrated circuit (ASIC). Circuit 50 includes a bus 65, a bus 66 and a bus 67. An arbiter (ARB) 87 arbitrates data transactions over bus 65. An arbiter (ARB) 88 arbitrates data transactions over bus 66. An arbiter (ARB) 89 arbitrates data transactions over bus 67. Various DMA devices are connected to busses 65, 66, and 67. The DMA devices connected to bus 65 are represented by a DMA device 51, a DMA device 52, a DMA device 53 and a DMA device 54. The DMA devices connected to bus 66 are represented by a DMA device 55, a DMA device 56, a DMA device 57 and a DMA device 58. The DMA devices connected to bus 67 are represented by a DMA device 59, a DMA device 60, a DMA device 61 and a DMA device 62.

DMA devices 51 through 62 can each be, for example, a scanner DMA, a scan compensator DMA, a video DMA, a color space converter DMA, a compressor DMA, a sharpen DMA, a scaler DMA, a multiplier DMA, a universal serial bus (USB) DMA, an Ethernet DMA, 1284 DMA, a media card DMA, or another device that performs DMA data transfers.

A multiplexer block 45 and a multiplexer block 46 are used to provide access to the RAM banks of RAM array 40. DMA devices present their target address to their respective bus arbiter as part of their bus request. The respective bus arbiter decodes whether a RAM bank is being addressed, decodes the selected bank, and passes the request up to a RAM arbiter 105. RAM arbiter 105 issues a grant once the desired RAM bank is available, and sets multiplexer block 46, and if the access is to read data, multiplexer 45 is also set, providing access for the requesting DMA device.

If a DMA device needs to communicate with another DMA device (peer to peer), these two DMA devices are connected to the same bus, and RAM arbiter 105 is not involved. The separate busses allow a peer-to-peer transfer to proceed without blocking access to RAM array 40, for the DMA devices located on the other busses. This process is simplified because each bus has its own arbiter.

Circuit 50 also includes a central processing unit (CPU) 69. A CPU arbiter and bridge 68 is used to arbitrate access for CPU 69. CPU arbiter and bridge 68 is able to access all of busses 65 through 67 as well as all of RAM banks 41 through 44. CPU arbiter and bridge 68 has a bus request port into each of the busses 65 through 67 for this purpose. CPU arbiter and bridge 68 also has a dedicated port into multiplexers 45 and 46. CPU arbiter and bridge 68 follows the same request protocol as bus arbiters 87 through 89 for access to RAM banks 41 through 44.

The multiport, multibus memory system allows for a large amount of concurrent accesses. For example, it is possible for DMA device 52 on bus 65 to access RAM bank 44, while DMA device 58 on bus 66 accesses RAM bank 42, while DMA device 59 on bus 67 accesses RAM bank 41 while CPU 69 accesses RAM bank 43. This represents the potential for a significant amount of parallel access. Such parallel RAM access increases system memory bandwidth and enables lower memory access latency.

Arbitration is designed to prohibit a dominant DMA device from monopolizing its bus and the RAM bank the DMA device is using. However, the effective bandwidth into the RAM bank used by a dominant DMA may be nearly saturated. This can be overcome by interleaving the address space of RAM array 40 across RAM banks 41 through 44. The address space is divided on the natural row size (page) boundary of RAM array 40. This way no extra precharge cycles are necessary when moving through the linear address space of RAM array 40. Linear address space begins with the first row of RAM bank 41, while the second row is found as the first row of RAM bank 42, and so forth. In this way the bandwidth consumption of a dominant DMA is spread across all four RAM banks, making it less intrusive on the multiport, multibus memory system.

A connection 111 between bus 65 and RAM arbiter 105 includes, for example, a RAM bank request input signal to RAM arbiter 105, a RAM bank number input signal to RAM arbiter 105 and a RAM bank grant signal from RAM arbiter 105. A connection 112 between bus 66 and RAM arbiter 105 includes, for example, a RAM bank request input signal to RAM arbiter 105, a RAM bank number input signal to RAM arbiter 105 and a RAM bank grant signal from RAM arbiter 105. A connection 113 between bus 67 and RAM arbiter 105 includes, for example, a RAM bank request input signal to RAM arbiter 105, a RAM bank number input signal to RAM arbiter 105 and a RAM bank grant signal from RAM arbiter 105. A connection 119 between CPU arbiter and bridge 68 and RAM arbiter 105 includes, for example, a RAM bank request input signal to RAM arbiter 105, a RAM bank number input signal to RAM arbiter 105 and a RAM bank grant signal from RAM arbiter 105.

A connection between each of DMA devices 51 through 62 and their respective busses 65 through 67, include control signals and data signals. The control signals typically include a bus request signal and target address from the DMA, as well as a grant signal to the DMA. The bus arbiter within each bus handles the control signals.

A connection 114 between bus 65 and CPU arbiter and bridge 68 includes control signals handled by bus arbitrator 87 and includes data signals. The control signals typically include a bus request signal from CPU arbiter and bridge 68, as well as a grant signal from bus arbitrator 87. A connection 115 between bus 66 and CPU arbiter and bridge 68 includes control signals handled by bus arbitrator 88 and includes data signals. The control signals typically include a bus request signal from CPU arbiter and bridge 68, as well as a grant signal from bus arbitrator 88. A connection 116 between bus 67 and CPU arbiter and bridge 68 includes control signals handled by bus arbitrator 89 and includes data signals. The control signals typically include a bus request signal from CPU arbiter and bridge 68, as well as a grant signal from bus arbitrator 87.

RAM arbiter 105 controls multiplexer block 45 using selection lines 117. RAM arbiter 105 controls multiplexer block 46 using selection lines 118.

Connection 71 from bus 65 to multiplexer block 46 represents data and control signals for a selected RAM bank. Connection 72 from bus 66 to multiplexer block 46 represents data and control signals for a selected RAM bank. Connection 73 from bus 67 to multiplexer block 46 represents data and control signals for a selected RAM bank. Connection 74 from CPU arbiter and bridge 68 to multiplexer block 46 represents data and control signals for a selected RAM bank.

Connection 75 from multiplexer block 46 to RAM bank 41 represents data for transfer to RAM bank 41 and represents address and control signals for memory controller 101. Connection 76 from multiplexer block 46 to RAM bank 42 represents data for transfer to RAM bank 42 and represents address and control signals for memory controller 102. Connection 77 from multiplexer block 46 to RAM bank 43 represents data for transfer to RAM bank 43 and represents address and control signals for memory controller 103. Connection 78 from multiplexer block 46 to RAM bank 44 represents data for transfer to RAM bank 44 and represents address and control signals for memory controller 104.

Connection 83 from RAM bank 41 to multiplexer block 45 represents data transferred from RAM bank 41. Connection 84 from RAM bank 42 to multiplexer block 45 represents data transferred from RAM bank 42. Connection 85 from RAM bank 43 to multiplexer block 45 represents data transferred from RAM bank 43. Connection 86 from RAM bank 44 to multiplexer block 45 represents data transferred from RAM bank 44.

Connection 79 from multiplexer block 45 to bus 65 represents data transferred from multiplexer block 45 to bus 65. Connection 80 from multiplexer block 45 to bus 66 represents data transferred from multiplexer block 45 to bus 66. Connection 81 from multiplexer block 45 to bus 67 represents data transferred from multiplexer block 45 to bus 67. Connection 82 from multiplexer block 45 to CPU arbiter and bridge 68 represents data transferred from multiplexer block 45 to CPU arbiter and bridge 68.

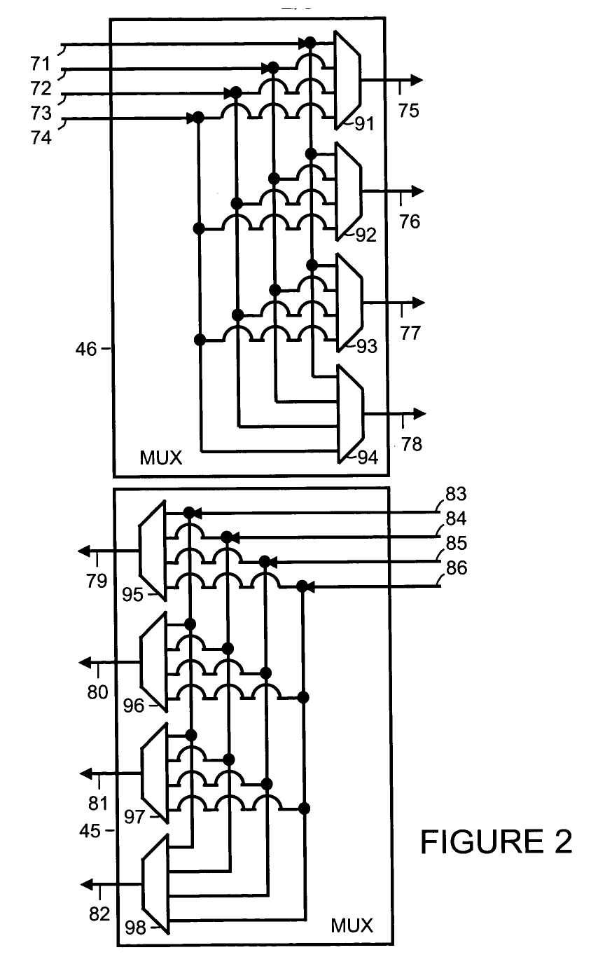

FIG. 2 is a simplified block diagram showing additional detail of multiplexer block 45 and multiplexer block 46. Multiplexer block 45 is shown to consist of a multiplexer 91, a multiplexer 92, a multiplexer 93 and a multiplexer 94. Multiplexer block 45 can contain more or fewer multiplexers depending upon the number of RAM banks within RAM array 40.

Multiplexer block 46 is shown to consist of a multiplexer 95, a multiplexer 96, a multiplexer 97 and a multiplexer 98. Multiplexer block 46 can contain more or fewer multiplexers depending upon the number of busses or other data destinations (e.g., CPU arbiter and bridge 68) within circuit 50.

FIG. 1 shows only an example of partition of entities between integrated circuits implementing a multi-port RAM array and multiple busses. As will be understood by persons of ordinary skill in the art, the multi-port RAM array and multiple busses can be contained on a single circuit. Alternatively, the multi-port RAM array and multiple busses can be contained on more than two circuits. Alternatively, for example, entities could be apportioned between two circuits differently than is shown in FIG. 1. For example, multiplexers could be included on a circuit that includes a DRAM array, rather than a circuit that includes multiple busses.

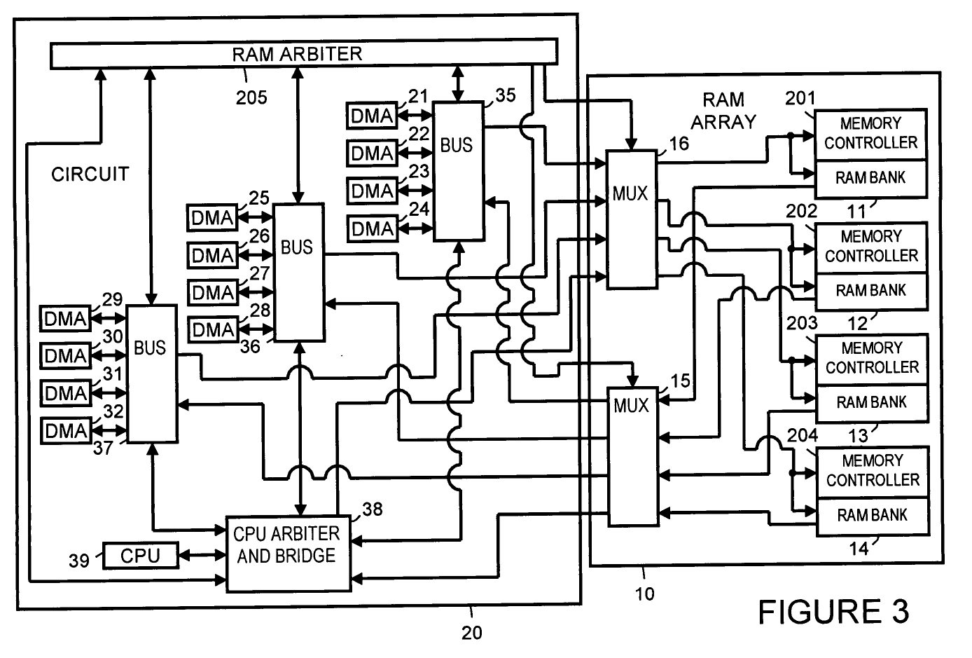

For example, FIG. 3 shows an alternative embodiment of a multiport, multibus memory system. A RAM array 10 includes a RAM bank 11, a RAM bank 12, a RAM bank 13 and a RAM bank 14. For example, RAM bank 11, RAM bank 12, RAM bank 13 and RAM 14 are all implemented using DRAM memory. Alternatively, other types of RAM such as static RAM (SRAM) or ferroelectric random access memory (FERAM) can be used to implement RAM bank 11, RAM bank 12, RAM bank 13 and RAM 14. A memory controller 201 controls memory access to RAM bank 11. A memory controller 202 controls memory access to RAM bank 12. A memory controller 203 controls memory access to RAM bank 13. A memory controller 204 controls memory access to RAM bank 14. A multiplexer 16 and a multiplexer 15 are included on the circuit housing RAM array 10.

A circuit 20 accesses data stored in RAM array 10. Circuit 20 is, for example, an application specific integrated circuit (ASIC). Circuit 20 includes a bus 35, a bus 36 and a bus 37. Various DMA devices are connected to busses 35, 36, and 37. The DMA devices connected to bus 35 are represented by a DMA device 21, a DMA device 22, a DMA device 23 and a DMA device 24. The DMA devices connected to bus 36 are represented by a DMA device 25, a DMA device 26, a DMA device 27 and a DMA device 28. The DMA devices connected to bus 37 are represented by a DMA device 29, a DMA device 30, a DMA device 31 and a DMA device 32.

DMA devices 21 through 32 can each be, for example, a scanner DMA, a scan compensator DMA, a video DMA, a color space converter DMA, a compressor DMA, a sharpen DMA, a scaler DMA, a multiplier DMA, a universal serial bus (USB) DMA, an Ethernet DMA, 1284 DMA, a media card DMA, or another device that performs DMA data transfers.

Multiplexer block 15 and multiplexer block 16 are used to provide access to the RAM banks of RAM array 10. DMA devices present their target address to their respective bus arbiter as part of their bus request. The respective bus arbiter decodes whether a RAM bank is being addressed, decodes the selected bank, and passes the request up to a RAM arbiter 205. RAM arbiter 205 issues a grant once the desired RAM bank is available, and sets multiplexer block 16, and if the access is to read data, multiplexer 15 is also set, providing access for the requesting DMA device.

If a DMA device needs to communicate with another DMA device (peer to peer), these two DMA devices are connected to the same bus, and RAM arbiter 105 is not involved. The separate busses allow a peer-to-peer transfer to proceed without blocking access to RAM array 10, for the DMA devices located on the other busses. This process is simplified because each bus has its own arbiter.

Circuit 20 also includes a central processing unit (CPU) 39. A CPU arbiter and bridge 38 is used to arbitrate access to CPU 39. CPU arbiter and bridge 38 is able to access all of busses 35 through 37 as well as all of RAM banks 11 through 14. CPU arbiter and bridge 38 has a bus request port into each of the busses 35 through 37 for this purpose. CPU arbiter and bridge 38 also has a dedicated port into multiplexers 15 and 16. CPU arbiter and bridge 38 follows the same request protocol as the bus arbiters for access to RAM banks 11 through 14.

The foregoing discussion discloses and describes merely exemplary methods and embodiments of the present invention. As will be understood by those familiar with the art, the invention may be embodied in other specific forms without departing from the spirit or essential characteristics thereof. Accordingly, the disclosure of the present invention is intended to be illustrative, but not limiting, of the scope of the invention, which is set forth in the following claims.

1. A memory system comprising:
a plurality of memory banks;
a plurality of busses; and,
a selection mechanism connected to every memory bank in the plurality of memory banks and to every bus in the plurality of busses, the selection mechanism being able to select any memory bank from the plurality of memory bank to connect to any bus from the plurality of busses.

2. A memory system as in claim 1 wherein the memory banks are composed of one of the following:
dynamic random access memory (DRAM);
static random access memory (SRAM);
ferroelectric random access memory (FERAM).

3. A memory system as in claim 1 wherein each memory bank includes a memory controller.

4. A memory system as in claim 1 wherein the selection mechanism comprises:
a first multiplexer block that selects a first memory bank from the plurality of memory banks as a source for data to be sent to one of the busses from the plurality of busses; and,
a second multiplexer block that selects a first bus from the plurality of busses as a source for data to be sent to one of the memory banks from the plurality of memory banks.

5. A memory system as in claim 1 wherein the selection mechanism is additionally connected to a central processing unit arbiter and bridge, the selection mechanism being able to select the central processing unit arbiter and bridge to connect to any memory bank from the plurality of memory banks.

6. A memory system as in claim 1 wherein each bus from the plurality of busses is connected to at least one direct memory access device.

7. A memory system as in claim 1 wherein the selection mechanism comprises:
a first multiplexer block that selects a first memory bank from the plurality of memory banks as a source for data to be sent to one of the busses from the plurality of busses;
a second multiplexer block that selects a first bus from the plurality of busses as a source for data to be sent to one of the memory banks from the plurality of memory banks; and,
a bus arbiter that controls selection made by the first multiplexer block and the second multiplexer block.

8. A circuit comprising:
a plurality of busses; and,
a selection mechanism connected to every bus in the plurality of busses, the selection mechanism also being for connection to every memory bank in a plurality of memory banks, the selection mechanism, when connected to the plurality of memory banks, being able to select any memory bank from the plurality of memory bank to connect to any bus from the plurality of busses.

9. A circuit as in claim 8 wherein the memory banks are composed of one of the following:
dynamic random access memory (DRAM);
static random access memory (SRAM);
ferroelectric random access memory (FERAM).

10. A circuit as in claim 8 wherein the selection mechanism comprises:
a first multiplexer block that selects a first memory bank from the plurality of memory banks as a source for data to be sent to one bus from the plurality of busses; and,
a second multiplexer block that selects a first bus from the plurality of busses as a source for data to be sent to one of the memory banks from the plurality of memory banks.

11. A circuit as in claim 8 additionally comprising:
a central processing unit arbiter and bridge, wherein the selection mechanism is additionally connected to the central processing unit arbiter and bridge, the selection mechanism being able to select the central processing unit arbiter and bridge to connect to any memory bank from the plurality of memory banks.

12. A circuit as in claim 8 wherein each bus from the plurality of busses is connected to at least one direct memory access device.

13. A circuit as in claim 8 wherein the selection mechanism comprises:
a first multiplexer block that selects a first memory bank from the plurality of memory banks as a source for data to be sent to one of the busses from the plurality of busses;
a second multiplexer block that selects a first bus from the plurality of busses as a source for data to be sent to one of the memory banks from the plurality of memory banks; and,
a bus arbiter that controls selection made by the first multiplexer block and the second multiplexer block.

14. A memory system comprising:
a plurality of memory banks;
a plurality of busses; and,
a selection means for selecting any memory bank from the plurality of memory bank to connect to any bus from the plurality of busses.

15. A memory system as in claim 14 wherein the memory banks are composed of one of the following:
dynamic random access memory (DRAM);
static random access memory (SRAM);
ferroelectric random access memory (FERAM).

16. A memory system as in claim 14 wherein each memory bank includes a memory controller.

17. A memory system as in claim 14 wherein the selection means comprises:
a first multiplexer block that selects a first memory bank from the plurality of memory banks as a source for data to be sent to one of the busses from the plurality of busses; and,
a second multiplexer block that selects a first bus from the plurality of busses as a source for data to be sent to one of the memory banks from the plurality of memory banks.

18. A memory system as in claim 14 wherein the selection means is additionally connected to a central processing unit arbiter and bridge, the selection means being able to select the central processing unit arbiter and bridge to connect to any memory bank from the plurality of memory banks.

19. A memory system as in claim 14 wherein each bus from the plurality of busses is connected to at least one direct memory access device.

20. A memory system as in claim 14 wherein the selection means comprises:
a first multiplexer block that selects a first memory bank from the plurality of memory banks as a source for data to be sent to one of the busses from the plurality of busses;
a second multiplexer block that selects a first bus from the plurality of busses as a source for data to be sent to one of the memory banks from the plurality of memory banks; and,
a bus arbiter that controls selection made by the first multiplexer block and the second multiplexer block.
